(19) United States
(12) Patent Application Publication
(10) Pub. No.: US 2025/0206234 A1
(43) Pub. Date: Jun. 26, 2025

(54) LUGGAGE RACK FOR REAR COMPARTMENT OF PICKUP TRUCK

(71) Applicant: Chengdu New Solution Automotive Technology Co., Ltd., Chengdu (CN)

(72) Inventor: Wei He, Chengdu (CN)

(21) Appl. No.: 18/989,793

(22) Filed: Dec. 20, 2024

(30) Foreign Application Priority Data
Dec. 26, 2023 (CN) 2023235548478

(51) Int. Cl. B60R 9/06

(52) U.S. Cl. CPC B60R 9/065

(57) ABSTRACT

A luggage rack for a rear compartment of a pickup truck, comprising a detachable rack, internal luggage compartments, expansion plate mechanisms and bottom fixing brackets, the internal luggage compartments are symmetrically arranged in the detachable rack and connected to the detachable rack in a detachable manner, the bottom fixing brackets are symmetrically arranged at a bottom of the detachable rack, the bottom fixing brackets are connected to the detachable rack in a detachable manner, bottoms of the internal luggage compartments are connected to the bottom fixing brackets in a detachable manner, rear walls of the internal luggage compartments and the bottom of the detachable rack are both provided with expansion plate mechanisms in a detachable manner; a detachable rack, internal luggage compartments, expansion plate mechanisms and bottom fixing brackets all adopt a detachable connection method, which makes assembly and replacement more convenient.

### 1. TECHNICAL FIELD

The invention relates to the technical field of luggage racks for rear compartments of pickup trucks, in particular to a luggage rack for a rear compartment of a pickup truck.

### 2. BACKGROUND ART

A pickup truck is a type of vehicle that adopts the front end and cab appearance of a car while featuring an open cargo compartment; it is characterized by its combination of comfort of cars, but also by its powerful power; it offers greater cargo capacity and off-road adaptability than cars; it is an important segment of the automotive market.

Due to its cargo compartment at the back, a pickup truck can accommodate a large amount of items; additionally, because the chassis of pickup trucks is relatively high, it can adapt to most terrains, making it a popular choice for people's transportation needs. However, in order to accommodate more luggage, many vehicle owners will install a luggage rack on the cargo compartment. Yet, the existing luggage racks generally lack good sealing and privacy, making it unsafe to store valuable items; furthermore, many items are directly fixed inside the luggage rack, which can be inconvenient when retrieving or searching for items;

Secondly, the main frame of the luggage rack is generally one-piece. As a result, when the main frame is damaged, it often requires a complete replacement, which can be wasteful.

Therefore, in view of the technical problems described above, a luggage rack for a rear compartment of a pickup truck is urgently needed.

### 3. SUMMARY OF THE INVENTION

The technical problem to be solved by the invention is to overcome the defects of the technology and provide a luggage rack for a rear compartment of a pickup truck.

In order to solve the above technical problems, the invention provides the following technical scheme: a luggage rack for a rear compartment of a pickup truck, comprising a detachable rack, internal luggage compartments, expansion plate mechanisms and bottom fixing brackets, wherein the internal luggage compartments are symmetrically arranged in the detachable rack and connected to the detachable rack in a detachable manner, the bottom fixing brackets are symmetrically arranged at a bottom of the detachable rack, the bottom fixing brackets are connected to the detachable rack in a detachable manner, bottoms of the internal luggage compartments are connected to the bottom fixing brackets in a detachable manner, rear walls of the internal luggage compartments and the bottom of the detachable rack are both provided with expansion plate mechanisms in a detachable manner;
the detachable rack comprises columns, upper crossbeams, lower crossbeams, lower crossbars and crossbar supports, four columns are symmetrically arranged, upper connecting heads are symmetrically arranged at an upper end of each column, and the upper crossbeam is arranged between two adjacent columns, ends of each upper crossbeam are respectively connected to the corresponding upper connecting heads by bolts, a lower connecting head is arranged at a lower end of each column, two lower crossbeams are symmetrically arranged, and the two lower crossbeams are arranged in parallel, ends of each lower crossbeam are respectively connected to the corresponding lower connecting heads by bolts, the bottom fixing brackets are respectively connected to the corresponding lower crossbeams by bolts, two lower crossbars are symmetrically arranged, the two lower crossbars are arranged in parallel, the crossbar supports are arranged at both ends of each lower crossbars, a plurality of adjustment screw holes are evenly arranged on each column, the crossbar supports are respectively connected to the corresponding adjustment screw holes by bolts, a plurality of upper crossbars are evenly arranged between the upper crossbeams and are arranged in parallel with each other, crossbar fixing brackets are arranged at both ends of each upper crossbar, and the crossbar fixing brackets are connected to the corresponding upper crossbeams by bolts;
a warning light installation groove is arranged on an inner side of a corner of each column, a plurality of holes penetrating the column are arranged in the warning light installation groove, a first warning light is arranged in the warning light installation groove, and the first warning light is connected to the column via bolts.

As an improvement, second warning lights are symmetrically arranged on the upper crossbeam at the rear end, the second warning lights are connected to the upper crossbeam by bolts, each column is provided with a plurality of grooves, each column is provided with a lifting ring;
a sliding groove is arranged on each upper crossbeam, each lower crossbeam, each lower crossbar and each upper crossbar.

As an improvement, each internal luggage compartment comprises a compartment body, a compartment door, hydraulic support rods, partitions, and upper mounting brackets, an upper end of the compartment door is rotatably connected to the compartment body via a rotating shaft, the hydraulic support rods are symmetrically installed on both side ends inside the compartment body, an upper fixing bracket is rotatably arranged on an upper end of each hydraulic support rod, the upper fixing brackets are connected to an upper part of the compartment door by bolts, a lower fixing bracket is rotatably arranged on a lower end of each hydraulic support rod, the lower fixing brackets are connected to lower side walls of the compartment body by bolts, an inner wall of the compartment body is evenly provided with multiple mounting groove rails, the mounting groove rails are arranged on upper, lower, and rear walls inside the compartment body, the mounting groove rails on a top and a bottom of the compartment body are both provided with mounting slots, inner upper and lower rear ends of each partition are provided with limit plates, notches are arranged at both the upper and lower ends of one same side of each partition, one end of each notch is provided with a pressing plate that extends upward above the notch, the pressing plate is provided with a snap, the limit plates on each partition are matched with the mounting groove rails, each snap is matched with the corresponding mounting slot, the upper mounting brackets are symmetrically arranged on the compartment body, and the upper mounting brackets are connected to the corresponding upper crossbeams by bolts, a lower end of the compartment body is connected to the corresponding bottom fixing brackets by bolts.

As an improvement, a storage plate is arranged between the two partitions, the storage plate and the partitions are connected by bolts, illumination lights are arranged on a lower half of the compartment door, a plurality of locks are evenly arranged on the lower half of the compartment door.

As an improvement, one of the compartment bodies is provided with detachable storage boxes, the compartment body with the storage boxes is provided with a detachable water storage tank.

As an improvement, the expansion plate mechanism comprises bottom plates, slide rails, slide bars and placement plates, two bottom plates are symmetrically arranged, each slide rail is arranged at an upper end of each bottom plate, each slide rail is slidably provided with the corresponding slide bar matched therewith, and the placement plates are arranged on the two slide bars.

As an improvement, the invention further comprises an upper frame and top plates, wherein the upper frame is arranged on the upper crossbeams and connected to the upper connecting heads via bolts, the several top plates are evenly arranged on the upper end of the upper frame.

Compared with the prior art, the invention has the following advantages:
1. the detachable rack, the internal luggage compartments, the expansion plate mechanisms and the bottom fixing brackets all adopt a detachable connection method, which makes assembly and replacement more convenient; the compartment bodies are symmetrically installed inside the detachable rack, expansion plate mechanisms are arranged on the rear walls of the compartment bodies and the bottom of the detachable rack, so that items can be placed inside the compartment bodies and on the expansion plate mechanisms, allowing more items to be placed;
a plurality of locks are evenly arranged on the lower half of the compartment door of the compartment body; this allows relatively valuable items to be stored inside the compartment body more securely; moreover, placing items inside the compartment body ensures better sealing and privacy;
2. the various members of the pickup truck luggage rack are connected by bolts, so it is easy to disassemble and transport, replace parts, etc.;
3. the placement plates on the extension plate mechanisms can be slid and pulled, making it more convenient to retrieve items placed on the placement plates inside the luggage rack;
4. the mounting groove rails are arranged on upper, lower, and rear walls inside the compartment body, the partitions are installed in the mounting groove rails through the limit plates, each snap is matched with the corresponding mounting slot to secure the partition; in the way, the partition can prevent items placed inside the compartment body from moving around, ensuring their safety; additionally, due to the cooperation of the mounting slot and the snap, it is easy to install and remove the partition, and the number of partitions can be adjusted according to usage, offering greater versatility;
5. the storage board is arranged between the two partitions, and small objects can be placed on the storage plate; in this way, both the space above and below the storage plate can be used to store items, allowing for more items to be placed; the storage plate and the partitions are connected by bolts, making them easy to disassemble and install, and they can be detached or installed according to the usage requirements;
6. the compartment door is supported by hydraulic support rods, which allows the compartment door to be held open and remain in any position after it is opened;
7. four columns are provide with first warning lights, second warning lights are symmetrically arranged on the upper crossbeam at the rear end, they can better show the range of the rack and enhance safety;
8. each column is provided with a lifting ring, which can be used as a device fixation point or anchor, making it more convenient.

### 4. BRIEF DESCRIPTION OF ACCOMPANY DRAWINGS

FIG. 1 is a schematic diagram of the front stereoscopic structure of a luggage rack for a rear compartment of a pickup truck of the invention.

FIG. 2 is a bottom view of the luggage rack for a rear compartment of a pickup truck of the invention.

FIG. 3 is a schematic diagram of the top stereoscopic structure of the luggage rack for a rear compartment of a pickup truck of the invention.

FIG. 4 is a disassembled state view 1 of the luggage rack for a rear compartment of a pickup truck of the invention.

FIG. 5 is a disassembled state view 2 of the luggage rack for a rear compartment of a pickup truck of the invention.

FIG. 6 is a disassembled state view 3 of the luggage rack for a rear compartment of a pickup truck of the invention.

FIG. 7 is a side view of the luggage rack for a rear compartment of a pickup truck of the invention.

FIG. 8 is a front view of the detachable rack of the luggage rack for a rear compartment of a pickup truck of the invention.

FIG. 9 is a left view of the detachable rack of the luggage rack for a rear compartment of a pickup truck of the invention.

FIG. 10 is a top view of the detachable rack of the luggage rack for a rear compartment of a pickup truck of the invention.

FIG. 11 is a bottom view of the detachable rack of the luggage rack for a rear compartment of a pickup truck of the invention.

FIG. 12 is a stereoscopic view of the detachable rack of the luggage rack for a rear compartment of a pickup truck of the invention.

FIG. 13 is a schematic diagram of the top stereoscopic structure of the column of the luggage rack for a rear compartment of a pickup truck of the invention.

FIG. 14 is a disassembled state view of the column of the luggage rack for a rear compartment of a pickup truck of the invention.

FIG. 15 is a schematic diagram of the bottom stereoscopic structure of the column of the luggage rack for a rear compartment of a pickup truck of the invention.

FIG. 16 is a rear view of the internal luggage compartment of the luggage rack for a rear compartment of a pickup truck of the invention.

FIG. 17 is a side view of the internal luggage compartment of the luggage rack for a rear compartment of a pickup truck of the invention.

FIG. 18 is a schematic diagram of the top stereoscopic structure of the internal luggage compartment of the luggage rack for a rear compartment of a pickup truck of the invention.

FIG. 19 is a front view of the internal luggage compartment of the luggage rack for a rear compartment of a pickup truck of the invention with the compartment door open.

FIG. 20 is a side view of the internal luggage compartment of the luggage rack for a rear compartment of a pickup truck of the invention with the compartment door open.

FIG. 21 is a schematic diagram of the top stereoscopic structure of the internal luggage compartment of the luggage rack for a rear compartment of a pickup truck of the invention with the compartment door open.

FIG. 22 is a schematic diagram of the bottom stereoscopic structure of the internal luggage compartment of the luggage rack for a rear compartment of a pickup truck of the invention with the compartment door open.

FIG. 23 is a schematic diagram of the structure of the storage box of the luggage rack for a rear compartment of a pickup truck of the invention.

FIG. 24 is a schematic diagram of the structure of the water storage tank of the luggage rack for a rear compartment of a pickup truck of the invention.

FIG. 25 is a schematic diagram of the structure of the partition of the luggage rack for a rear compartment of a pickup truck of the invention.

FIG. 26 is a partial enlarged view of point A in FIG. 22.

FIG. 27 is a partial enlarged view of point B in FIG. 6.

FIG. 28 is a partial enlarged view of point C in FIG. 12.

FIG. 29 is a partial enlarged view of point D in FIG. 3

As shown in the figures:
1 bottom fixing bracket, 2 column, 3 upper crossbeam, 4 lower crossbeam, 5 lower crossbar, 6 crossbar support, 7 upper connecting head, 8 lower connecting head, 9 adjustment screw hole, 10 upper crossbar, 11 crossbar fixing bracket, 12 warning light installation groove, 13 hole, 14 first warning light, 15 second warning light, 16 groove, 17 lifting ring, 18 sliding groove, 19 compartment body, 20 compartment door, 21 hydraulic support rod, 22 partition, 23 upper mounting bracket, 24 upper fixing bracket, 25 lower fixing bracket, 26 mounting groove rail, 27 mounting slot, 28 limit plate, 29 notch, 30 pressing plate, 31 snap, 32 storage plate, 33 illumination light, 34 lock, 35 cylinder, 36 storage box, 37 water storage tank, 38 bottom plate, 39 slide rail, 40 slide bar, 41 upper frame, 42 top plate, 43 placement plate.

### 5. SPECIFIC EMBODIMENT OF THE INVENTION

In order to make the objects, technical schemes and advantages of the embodiments of the invention clearer, the technical schemes in the embodiments of the invention will be clearly and completely described below in combination with the accompanying drawings in the embodiments of the invention. Obviously, the described embodiments are some, but not all embodiments of the invention.

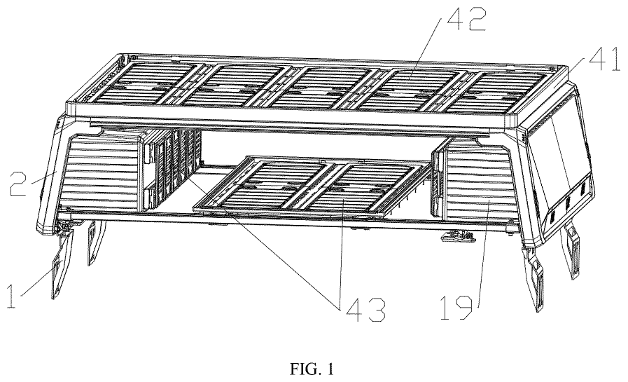

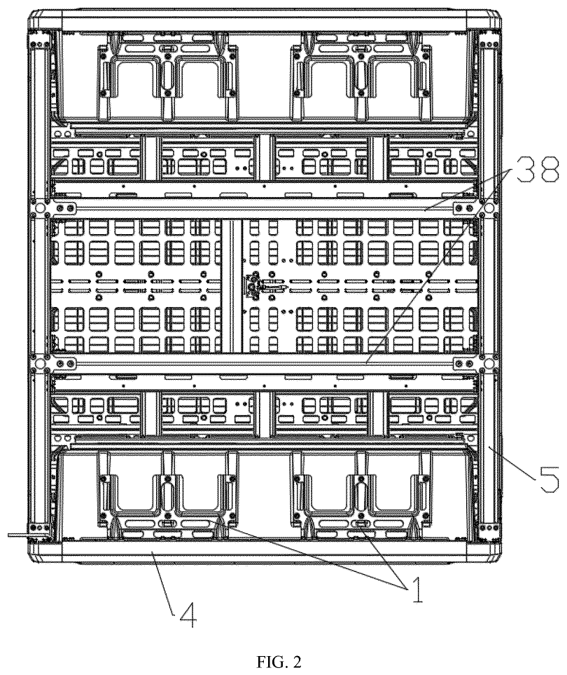

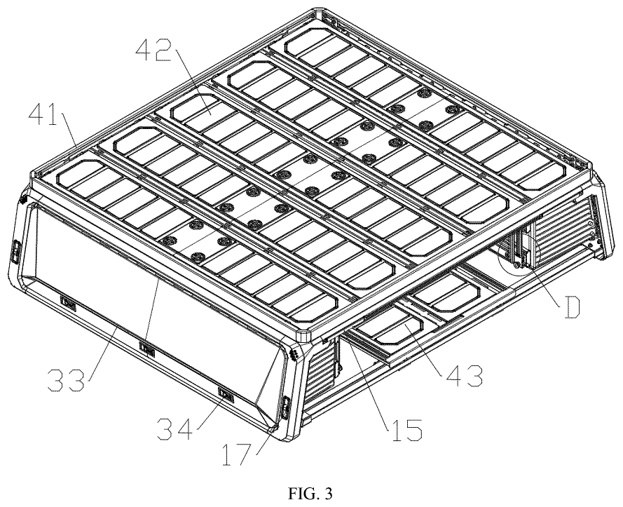

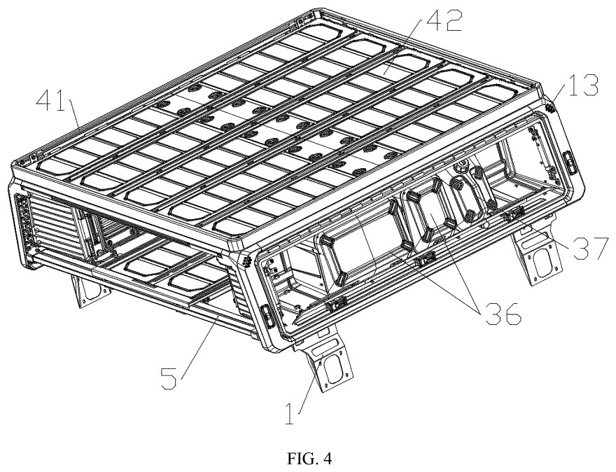

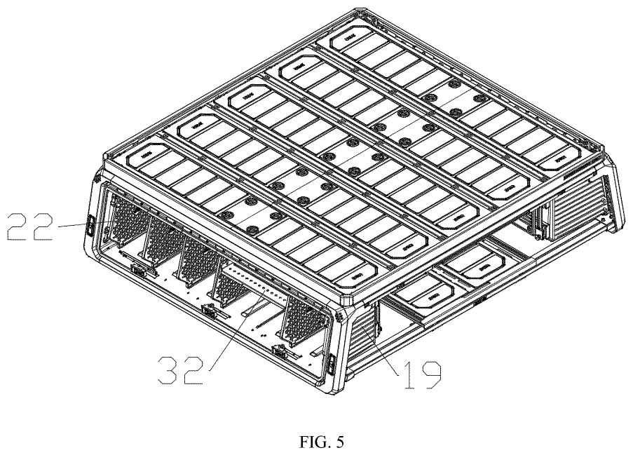

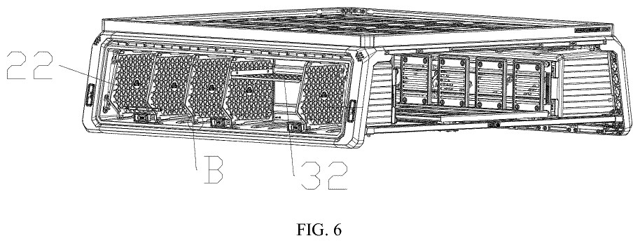

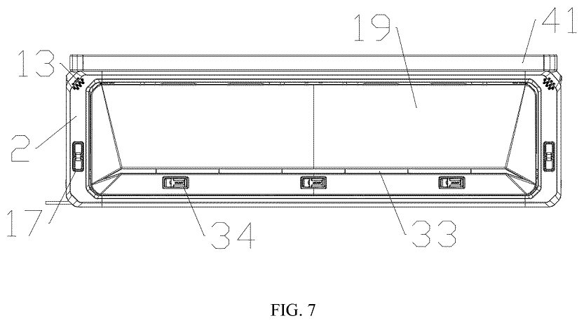

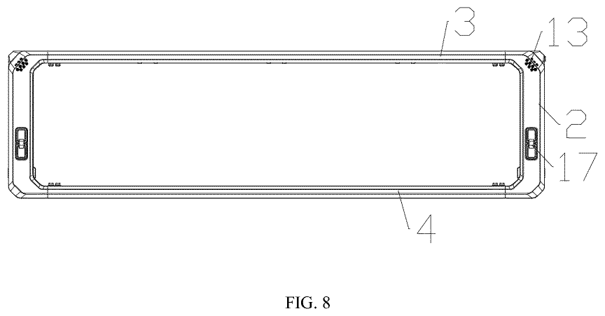

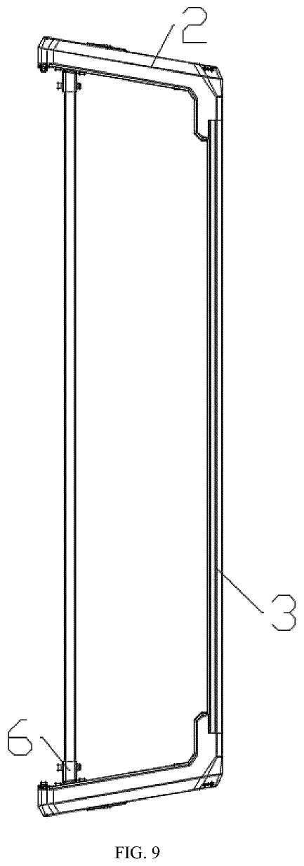

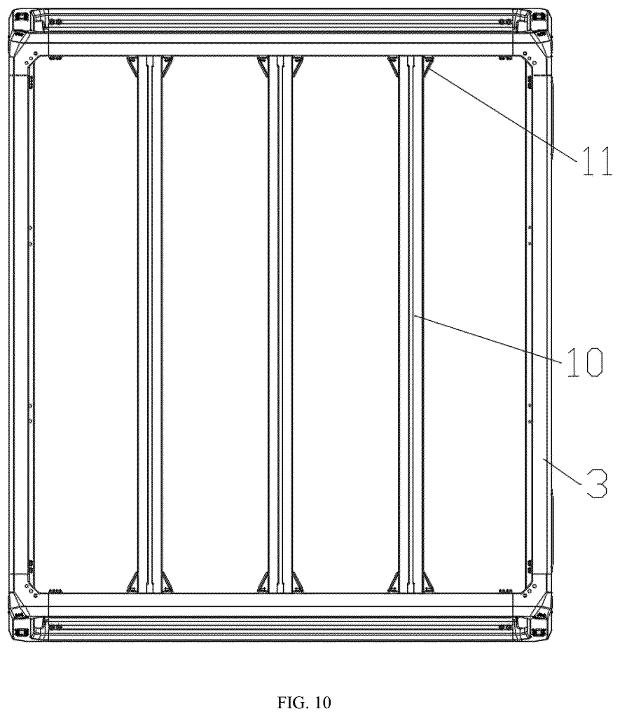

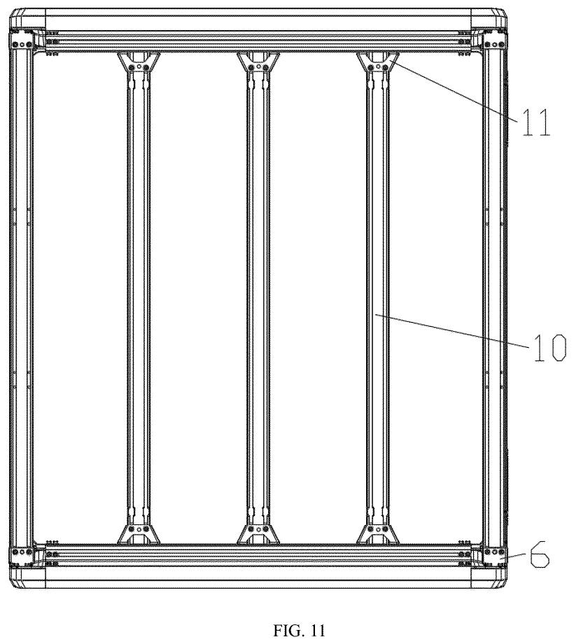

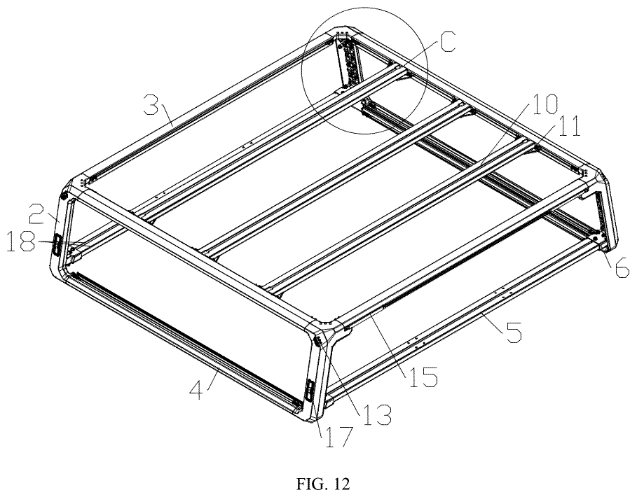

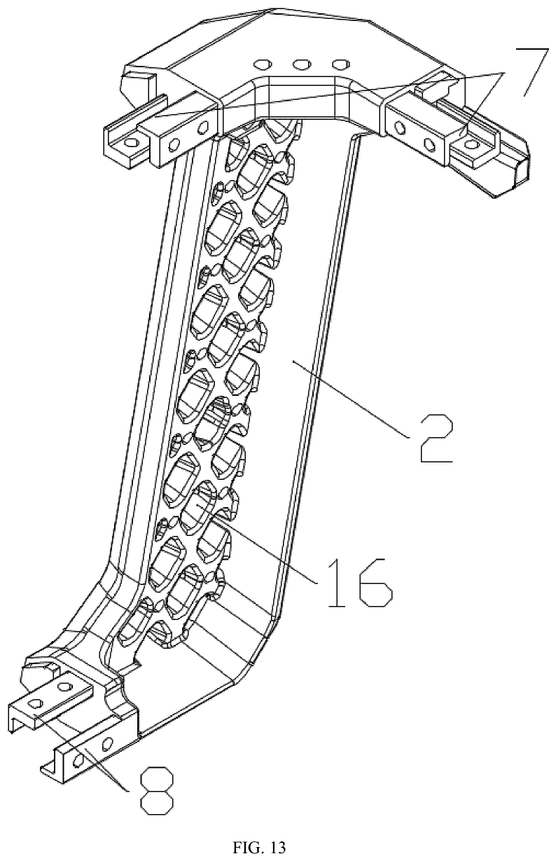

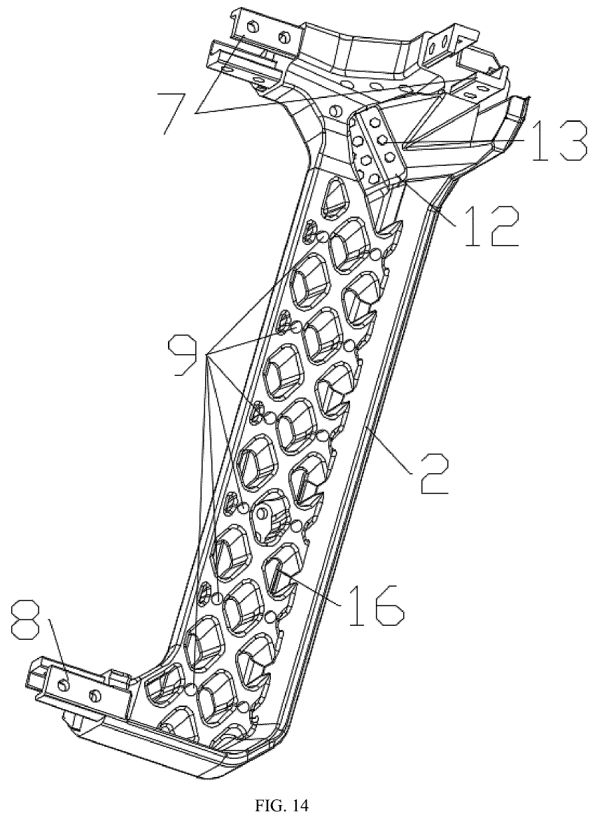

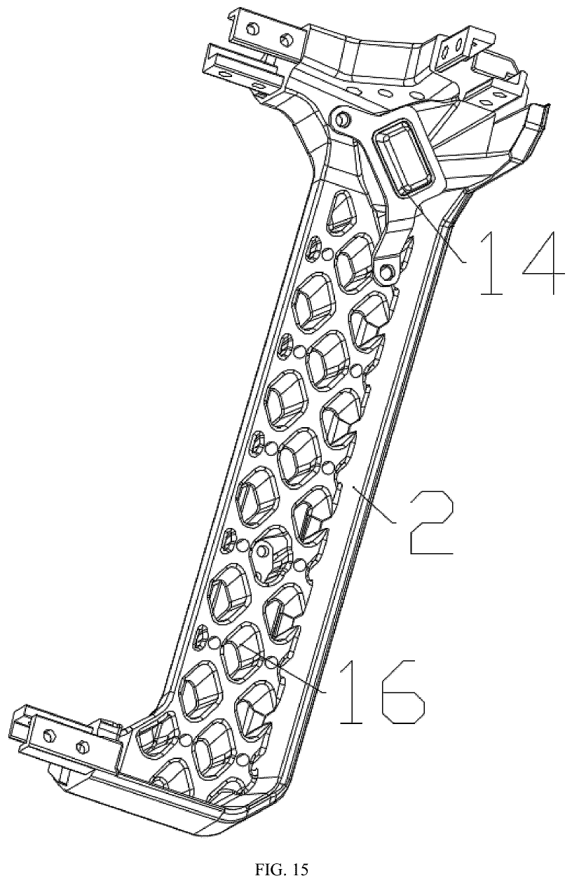

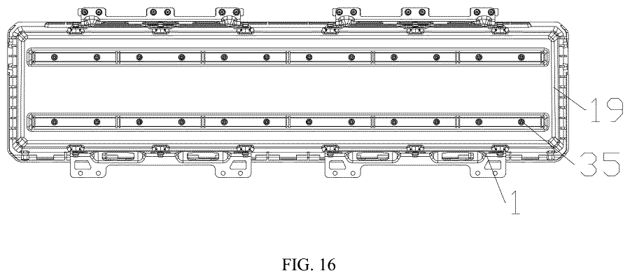

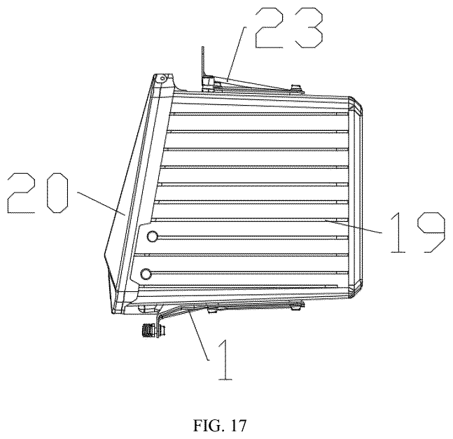

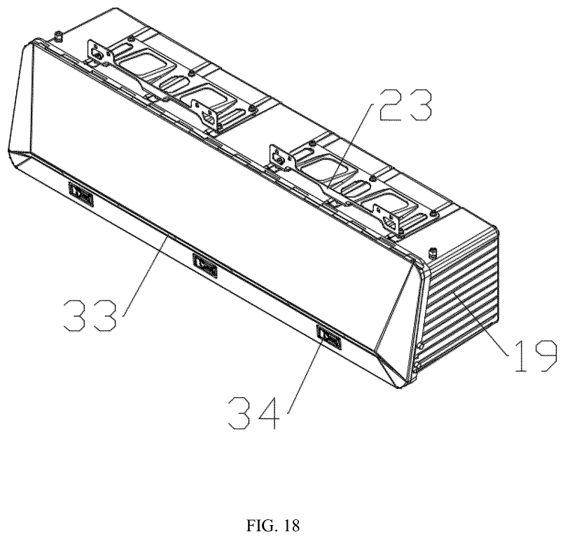

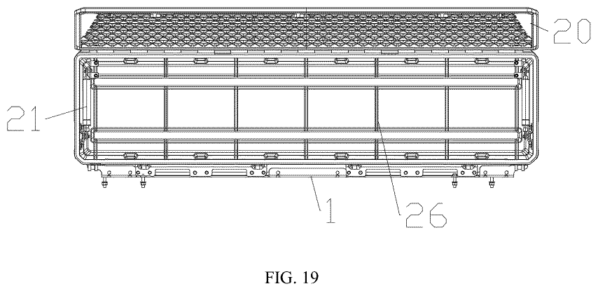

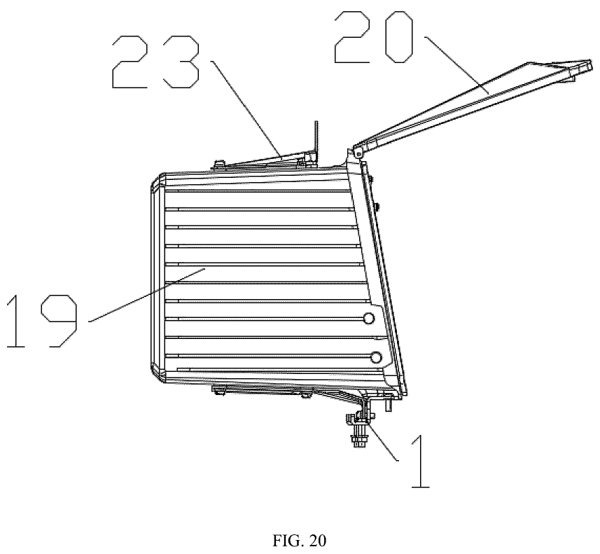

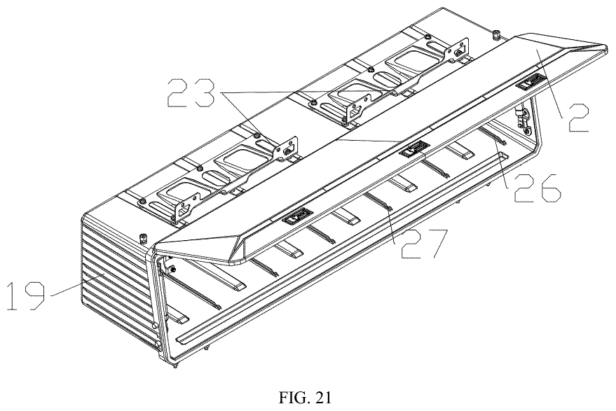

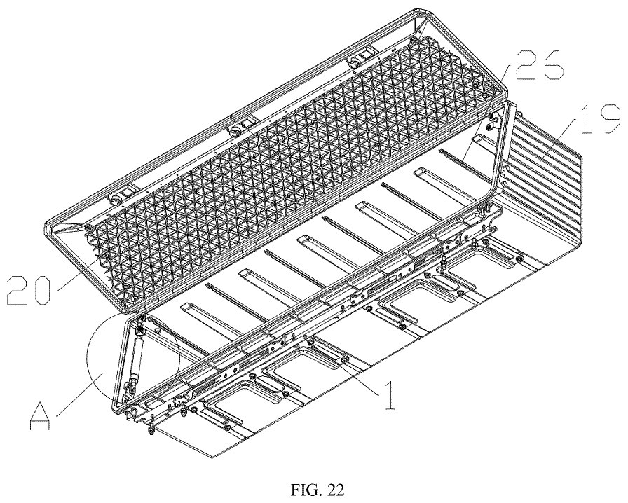

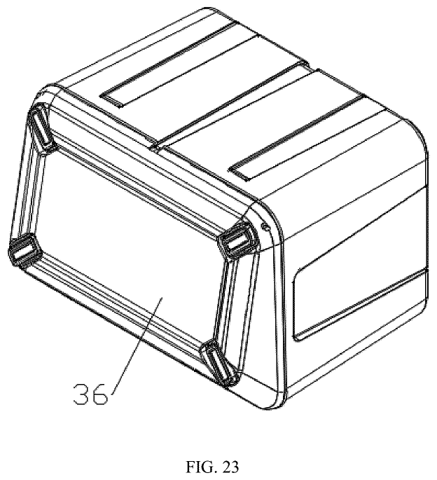

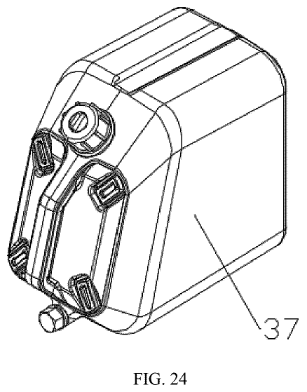

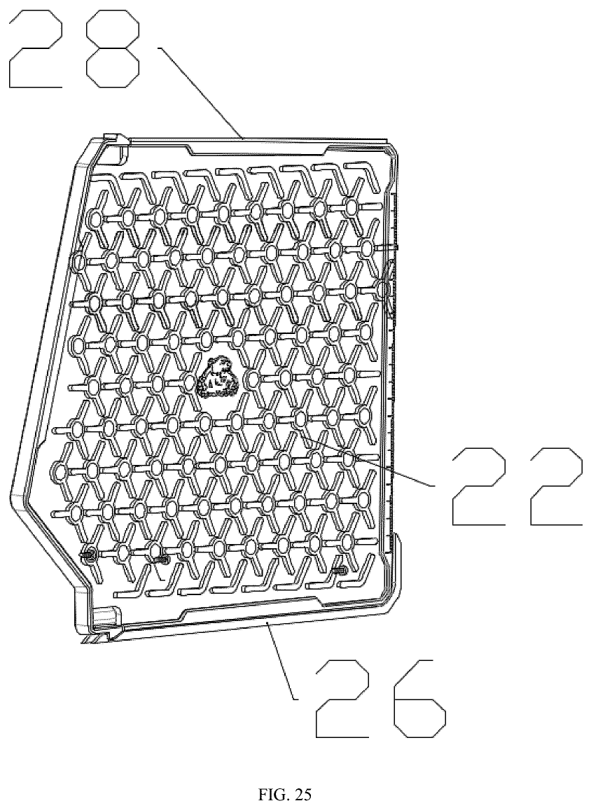

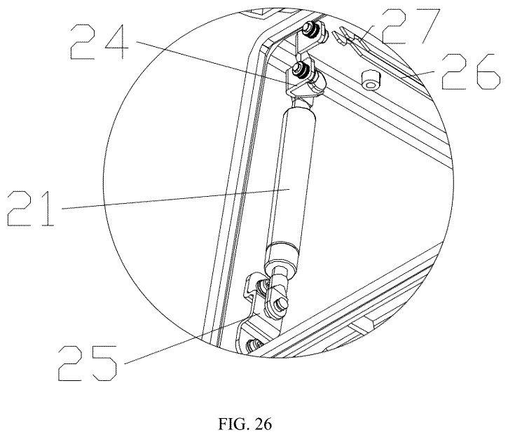

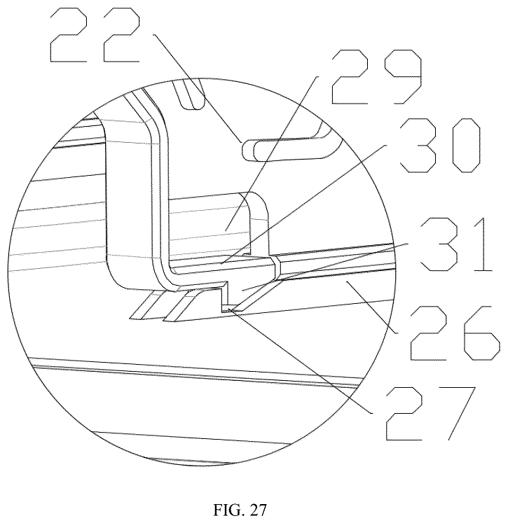

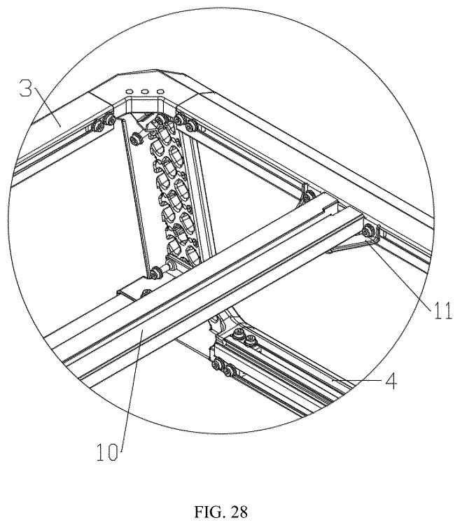

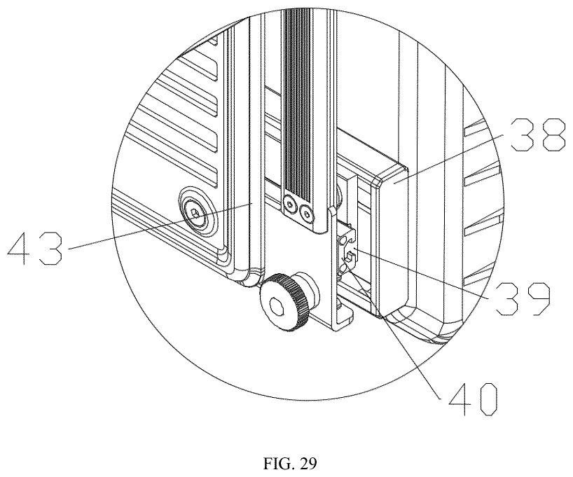

Combined with FIG. 1-FIG. 29, a luggage rack for a rear compartment of a pickup truck, comprising a detachable rack, internal luggage compartments, expansion plate mechanisms and bottom fixing brackets 1, the internal luggage compartments are symmetrically arranged in the detachable rack and connected to the detachable rack in a detachable manner, the bottom fixing brackets 1 are symmetrically arranged at a bottom of the detachable rack, the bottom fixing brackets 1 are connected to the detachable rack in a detachable manner, bottoms of the internal luggage compartments are connected to the bottom fixing brackets 1 in a detachable manner, rear walls of the internal luggage compartments and the bottom of the detachable rack are both provided with expansion plate mechanisms in a detachable manner;
the detachable rack comprises columns 2, upper crossbeams 3, lower crossbeams 4, lower crossbars 5 and crossbar supports 6, four columns 2 are symmetrically arranged, upper connecting heads 7 are symmetrically arranged at an upper end of each column 2, and the upper crossbeam 3 is arranged between two adjacent columns 2, ends of each upper crossbeam 3 are respectively connected to the corresponding upper connecting heads 7 by bolts, a lower connecting head 8 is arranged at a lower end of each column 2, two lower crossbeams 4 are symmetrically arranged, and the two lower crossbeams 4 are arranged in parallel, ends of each lower crossbeam 4 are respectively connected to the corresponding lower connecting heads 8 by bolts, the bottom fixing brackets 1 are respectively connected to the corresponding lower crossbeams 4 by bolts, two lower crossbars 5 are symmetrically arranged, the two lower crossbars 5 are arranged in parallel, the crossbar supports 6 are arranged at both ends of each lower crossbars 5, a plurality of adjustment screw holes 9 are evenly arranged on each column 2, the crossbar supports 6 are respectively connected to the corresponding adjustment screw holes 9 by bolts, which can facilitate the adjustment of the installation height of the lower crossbars 5 and the expansion of other accessories; a plurality of upper crossbars 10 are evenly arranged between the upper crossbeams 3 and are arranged in parallel with each other, crossbar fixing brackets 11 are arranged at both ends of each upper crossbar 10, and the crossbar fixing brackets 11 are connected to the corresponding upper crossbeams 3 by bolts;
a warning light installation groove 12 is arranged on an inner side of a corner of each column 2, a plurality of holes 13 penetrating the column 2 are arranged in the warning light installation groove 12, a first warning light 14 is arranged in the warning light installation groove 12, and the first warning light 14 is connected to the column 2 via bolts; second warning lights 15 are symmetrically arranged on the upper crossbeam 3 at the rear end, the second warning lights 15 are connected to the upper crossbeam 3 by bolts, which can better show the range of the rack and enhance safety;
each column 2 is provided with a plurality of grooves 16, which can help reduce the weight of the product; each column 2 is provided with a lifting ring 17, which can be used as a device fixation point or anchor, making it more convenient;
a sliding groove 18 is arranged on each upper crossbeam 3, each lower crossbeam 4, each lower crossbar 5 and each upper crossbar 10.

Each internal luggage compartment comprises a compartment body 19, a compartment door 20, hydraulic support rods 21, partitions 22, and upper mounting brackets 23, an upper end of the compartment door 20 is rotatably connected to the compartment body 19 via a rotating shaft, the hydraulic support rods 21 are symmetrically installed on both side ends inside the compartment body 19, an upper fixing bracket 24 is rotatably arranged on an upper end of each hydraulic support rod 21, the upper fixing brackets 24 are connected to an upper part of the compartment door 20 by bolts, a lower fixing bracket 25 is rotatably arranged on a lower end of each hydraulic support rod 21, the lower fixing brackets 25 are connected to lower side walls of the compartment body 19 by bolts, the compartment door 20 is supported by hydraulic support rods 21, which allows the compartment door 20 to be held open and remain in any position after it is opened; an inner wall of the compartment body 19 is evenly provided with multiple mounting groove rails 26, the mounting groove rails 26 are arranged on upper, lower, and rear walls inside the compartment body 19, the mounting groove rails 26 on a top and a bottom of the compartment body 19 are both provided with mounting slots 27, inner upper and lower rear ends of each partition 22 are provided with limit plates 28, notches 29 are arranged at both the upper and lower ends of one same side of each partition 22, one end of each notch 29 is provided with a pressing plate 30 that extends upward above the notch 29, the pressing plate 30 is provided with a snap 31, the limit plates 28 on each partition 22 are matched with the mounting groove rails 26, each snap 31 is matched with the corresponding mounting slot 27 to secure the partition 22, the partition 22 can prevent items placed inside the compartment body 19 from moving around, ensuring their safety; additionally, it is easy to install and remove, and the number of partitions can be adjusted according to usage, offering greater versatility; the upper mounting brackets 23 are symmetrically arranged on the compartment body 19, and the upper mounting brackets 23 are connected to the corresponding upper crossbeams 3 by bolts, a lower end of the compartment body 19 is connected to the corresponding bottom fixing brackets 1 by bolts.

A storage plate 32 is arranged between the two partitions 22, allowing small items to be placed on the storage plate 32; this design enables the space above and below the storage plate 32 to be used for storing items, increasing the overall storage capacity; the storage plate 32 and the partitions 22 are connected by bolts, making it easy to assemble and disassemble, and allowing adjustments based on usage requirements;
illumination lights 33 are arranged on a lower half of the compartment door 20, which facilitates lighting inside the compartment body 19 when retrieving items in the dark; a plurality of locks 34 are evenly arranged on the lower half of the compartment door 20, enhancing security.

A rear wall of the compartment body 19 is evenly provided with a plurality of cylinders 35 with screw holes, which facilitates connection to the bottom plates 38 of the expansion plate mechanisms by using bolts.

One of the compartment bodies 19 is provided with detachable storage boxes 36, the compartment body 19 with the storage boxes 36 is provided with a detachable water storage tank 37.

The expansion plate mechanism comprises bottom plates 38, slide rails 39, slide bars 40 and placement plates 43, two bottom plates 38 are symmetrically arranged, each slide rail 39 is arranged at an upper end of each bottom plate 38, each slide rail 39 is slidably provided with the corresponding slide bar 40 matched therewith, and the placement plates 43 are arranged on the two slide bars 40.

The invention further comprises an upper frame 41 and top plates 42, the upper frame 41 is arranged on the upper crossbeams 3 and cooperates with the sliding groove 18 to increase stability, and the upper frame 41 is connected to the upper connecting heads 7 via bolts, the several top plates 42 are evenly arranged on the upper end of the upper frame 41.

In the specific implementation of the invention, during use, first, the detachable rack is assembled by using bolts, the compartment bodies 19 are placed inside the detachable rack and connected to the corresponding upper crossbeams 3 through bolts by using the upper mounting brackets 23; the bottom fixing brackets 1 are connected to the corresponding lower crossbeams 4 through bolts; then, the bottom fixing brackets 1 are connected to the compartment bodies 19 through bolts; next, the the bottom fixing brackets 1 are connected to the rear compartment of the pickup truck through bolts, thereby securing the luggage rack in place; the upper frame 41 is connected to the upper connecting heads 7 via bolts, and then the top plates 42 are installed on the upper frame 41; at this point, the luggage rack is fully assembled and installed;
items can be placed on the top plates 42, inside the compartment bodies 19, and on the extension plate mechanisms. The placement plates 43 on the extension plate mechanisms can be slid and pulled, making it more convenient to retrieve items placed on the placement plates 43 inside the luggage rack;
additionally, a plurality of locks 34 are evenly arranged on the lower half of the compartment door 20 of the compartment body 19; this allows relatively valuable items to be stored inside the compartment body 19 more securely; moreover, placing items inside the compartment body 19 ensures better sealing and privacy; items can also be placed in the storage boxes 36, and water can be stored in the water storage tank 37;
the storage boxes 36 and the water storage tank 37 can be placed inside the compartment body 19 for item and water storage purposes, and quantity can be adjusted based on needs; items can be placed between the partitions 22 inside the compartment body 19, or small objects can be placed on the storage plate 32; in this way, both the space above and below the storage plate 32 can be used to store items, allowing for more items to be placed; the storage plate 32 and the partitions 22 are connected by bolts, making them easy to disassemble and install, and they can be detached or installed according to the usage requirements; the mounting groove rails 26 are arranged on upper, lower, and rear walls inside the compartment body 19, the partitions 22 are installed in the mounting groove rails 26 through the limit plates 28, each snap 31 is matched with the corresponding mounting slot 27 to secure the partition 22; in the way, the partition 22 can prevent items placed inside the compartment body 19 from moving around, ensuring their safety; additionally, due to the cooperation of the mounting slot 27 and the snap 31, it is easy to install and remove the partition 22, and the number of partitions 22 can be adjusted according to usage, offering greater versatility.

A rear wall of the compartment body 19 is evenly provided with a plurality of cylinders 35 with screw holes, which facilitates connection to the bottom plates 38 of the expansion plate mechanisms by using bolts.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A luggage rack for a rear compartment of a pickup truck, comprising a detachable rack, internal luggage compartments, expansion plate mechanisms and bottom fixing brackets, wherein the internal luggage compartments are symmetrically arranged in the detachable rack and connected to the detachable rack in a detachable manner, the bottom fixing brackets are symmetrically arranged at a bottom of the detachable rack, the bottom fixing brackets are connected to the detachable rack in a detachable manner, bottoms of the internal luggage compartments are connected to the bottom fixing brackets in a detachable manner, rear walls of the internal luggage compartments and the bottom of the detachable rack are both provided with expansion plate mechanisms in a detachable manner;
the detachable rack comprises columns, upper crossbeams, lower crossbeams, lower crossbars and crossbar supports, four columns are symmetrically arranged, upper connecting heads are symmetrically arranged at an upper end of each column, and the upper crossbeam is arranged between two adjacent columns, ends of each upper crossbeam are respectively connected to the corresponding upper connecting heads by bolts, a lower connecting head is arranged at a lower end of each column, two lower crossbeams are symmetrically arranged, and the two lower crossbeams are arranged in parallel, ends of each lower crossbeam are respectively connected to the corresponding lower connecting heads by bolts, the bottom fixing brackets are respectively connected to the corresponding lower crossbeams by bolts, two lower crossbars are symmetrically arranged, the two lower crossbars are arranged in parallel, the crossbar supports are arranged at both ends of each lower crossbars, a plurality of adjustment screw holes are evenly arranged on each column, the crossbar supports are respectively connected to the corresponding adjustment screw holes by bolts, a plurality of upper crossbars are evenly arranged between the upper crossbeams and are arranged in parallel with each other, crossbar fixing brackets are arranged at both ends of each upper crossbar, and the crossbar fixing brackets are connected to the corresponding upper crossbeams by bolts;
a warning light installation groove is arranged on an inner side of a corner of each column, a plurality of holes penetrating the column are arranged in the warning light installation groove, a first warning light is arranged in the warning light installation groove, and the first warning light is connected to the column via bolts.

2. The luggage rack for a rear compartment of a pickup truck of claim 1, wherein second warning lights are symmetrically arranged on the upper crossbeam at the rear end, the second warning lights are connected to the upper crossbeam by bolts, each column is provided with a plurality of grooves, each column is provided with a lifting ring;
a sliding groove is arranged on each upper crossbeam, each lower crossbeam, each lower crossbar and each upper crossbar.

3. The luggage rack for a rear compartment of a pickup truck of claim 1, wherein each internal luggage compartment comprises a compartment body, a compartment door, hydraulic support rods, partitions, and upper mounting brackets, an upper end of the compartment door is rotatably connected to the compartment body via a rotating shaft, the hydraulic support rods are symmetrically installed on both side ends inside the compartment body, an upper fixing bracket is rotatably arranged on an upper end of each hydraulic support rod, the upper fixing brackets are connected to an upper part of the compartment door by bolts, a lower fixing bracket is rotatably arranged on a lower end of each hydraulic support rod, the lower fixing brackets are connected to lower side walls of the compartment body by bolts, an inner wall of the compartment body is evenly provided with multiple mounting groove rails, the mounting groove rails are arranged on upper, lower, and rear walls inside the compartment body, the mounting groove rails on a top and a bottom of the compartment body are both provided with mounting slots, inner upper and lower rear ends of each partition are provided with limit plates, notches are arranged at both the upper and lower ends of one same side of each partition, one end of each notch is provided with a pressing plate that extends upward above the notch, the pressing plate is provided with a snap, the limit plates on each partition are matched with the mounting groove rails, each snap is matched with the corresponding mounting slot, the upper mounting brackets are symmetrically arranged on the compartment body, and the upper mounting brackets are connected to the corresponding upper crossbeams by bolts, a lower end of the compartment body is connected to the corresponding bottom fixing brackets by bolts.

4. The luggage rack for a rear compartment of a pickup truck of claim 3, wherein a storage plate is arranged between the two partitions, the storage plate and the partitions are connected by bolts, illumination lights are arranged on a lower half of the compartment door, a plurality of locks are evenly arranged on the lower half of the compartment door.

5. The luggage rack for a rear compartment of a pickup truck of claim 3, wherein a rear wall of the compartment body is evenly provided with a plurality of cylinders with screw holes.

6. The luggage rack for a rear compartment of a pickup truck of claim 3, wherein one of the compartment bodies is provided with detachable storage boxes, the compartment body with the storage boxes is provided with a detachable water storage tank.

7. The luggage rack for a rear compartment of a pickup truck of claim 1, wherein the expansion plate mechanism comprises bottom plates, slide rails, slide bars and placement plates, two bottom plates are symmetrically arranged, each slide rail is arranged at an upper end of each bottom plate, each slide rail is slidably provided with the corresponding slide bar matched therewith, and the placement plates are arranged on the two slide bars.

8. The luggage rack for a rear compartment of a pickup truck of claim 1, further comprising an upper frame and top plates, wherein the upper frame is arranged on the upper crossbeams and connected to the upper connecting heads via bolts, the several top plates are evenly arranged on the upper end of the upper frame.
